(19) United States
(12) Patent Application Publication
(10) Pub. No.: US 2014/0327175 A1
(43) Pub. Date: Nov. 6, 2014

(54) Stretch Film Using a Multi-Manifold Die

(71) Applicant: Paragon Films, Inc., Broken Arrow, OK (US)

(72) Inventor: Shaun Eugene Pirtle, Coweta, OK (US)

(73) Assignee: PARAGON FILMS, INC., Broken Arrow, OK (US)

(21) Appl. No.: 14/267,375

(22) Filed: May 1, 2014

Related U.S. Application Data
(60) Provisional application No. 61/818,335, filed on May 1, 2013.

(51) Int. Cl. B29C 47/30; B29C 47/00; B29C 47/06

(52) U.S. Cl. CPC B29C 47/30; B29C 47/06; B29C 47/0021
USPC 264/173.16; 425/463

(57) ABSTRACT

A die for forming a stretch film includes at least: a primary passage for receiving a primary stream, the primary passage having a length extending from a die inlet opening to a die outlet opening; and a flow assembly for supplying a secondary stream to the primary passage at a secondary passage opening. A method for forming a stretch film includes: introducing a primary stream to a primary passage of a die at a die inlet opening, the primary passage having a length extending from the die inlet opening to a die outlet opening; supplying a secondary stream to the primary passage at a secondary passage opening; combining the primary stream and the secondary stream to create a combined stream; passing the combined stream through said die outlet opening; and passing the combined stream from the die outlet opening to a casting unit, thereby forming a film web.

### FIELD

The present invention relates generally to stretch films and methods for producing stretch films, and in a particular though non-limiting embodiment, to stretch films and methods for producing stretch films wherein continuous profiles, ribbons, bands, and strands of differing materials are introduced into the polymer stretch film web in situ using a multi-manifold die.

### BACKGROUND

Stretch films are widely used in a variety of bundling and packaging applications. For example, stretch films have become a common method of securing bulky loads such as boxes, merchandise, produce, equipment, parts, and other similar items on pallets. Such films are typically made from various polyethylene resins and are single or multilayer products. An additive known as a cling agent is frequently used to ensure that adjacent layers of film will cling to each other.

Stretch films known in the art often include multiple discrete layers that allow for the overall performance of the film to be modified by using differentiated resins in any of the internal or external layers of the structure. The percentage or relative thickness for any single layer for one of these types of structures is typically constrained due to limitations of the production equipment, including extrusion capability, feedblock and die configuration, the overall extrusion rate or output, and the number of layers available. Furthermore, the rheology of the polymers also limits the thickness of a layer or layers of the film.

Typical cast film extrusion processes require a minimum of about 7% to about 8% (some as high as about 10%) of the overall structure in each layer in order to a produce a functional film. Properties such as load holding force, tear propagation, extensibility, cling, puncture, and clarity can be independently modified, within the constraints of the polymer systems being employed, by introducing a resin with suitable performance characteristics into one or more of the available layers. However, there may be more desired properties than layers available, and/or the desired performance may require a significantly higher percentage of a specific polymer than is feasible.

Although discrete polymer layers tend to provide the highest relative performance with relation to gauge versus products that utilize resin blending, specific performance characteristics, including cling and release, can be achieved via resin blending. However, outside of those exceptions, the strategy of blending polymers to reduce cost or optimize a specific performance characteristic generally results in a negative impact on the overall film properties.

One method known in the art for improving film performance outside of polymer selection is folding the edges of the film after the film has been quenched and slit. However, such method only affects the external layer(s) of the film, and can require extraneous processes. Another issue is that the folded areas of film create regions that are significantly thicker versus the rest of the film, resulting in gauge bands when the film is wound. These gauge bands can cause difficulties during the unwinding process, including blocking and film failure. The gauge bands can also result in core crushing and difficulty in removing the film roll from the shaft during production. In order to minimize these issues, typically the film or the roll is oscillated in order distribute the thickened region over as wide of an area as possible. However, this results in rolls with poor roll conformation.

There is, therefore, a long-standing yet unmet need for stretch films with improved film performance. There is a further unmet need for methods of producing such improved stretch films.

### SUMMARY

Dies and methods for forming stretch films are provided. A die for forming a stretch film includes at least: a primary passage for receiving a primary stream, the primary passage having a length extending from a die inlet opening to a die outlet opening; and a flow assembly for supplying a secondary stream to the primary passage at a secondary passage opening located upstream of the die outlet opening.

A method for forming a stretch film includes at least the following steps: introducing a primary stream to a primary passage of a die at a die inlet opening, the primary passage having a length extending from the die inlet opening to a die outlet opening; supplying a secondary stream to the primary passage at a secondary passage opening located upstream of the die outlet opening using a flow assembly; combining the primary stream and the secondary stream to create a combined stream; passing the combined stream through said die outlet opening; and passing the combined stream from the die outlet opening to a casting unit, thereby forming a film web.

### BRIEF DESCRIPTION OF THE DRAWINGS

For a further understanding of the nature, objects and advantages of the present invention, reference should be had to the following descriptions read in conjunction with the following drawings:

FIG. 1 illustrates a stretch film according to example embodiments, wherein bands of polymer are placed in an internal layer of the stretch film.

FIG. 2 illustrates a stretch film according to example embodiments, wherein bands of polymer are placed on an external skin layer of the stretch film.

FIG. 3 illustrates a stretch film according to example embodiments, wherein strands or strings of polymer are placed on an external skin layer of the stretch film.

FIG. 4 illustrates a stretch film according to example embodiments, wherein strands or strings of polymer are placed in an external skin layer of the stretch film.

### DETAILED DESCRIPTION

The following description is not to be taken in a limiting sense, but is made merely for the purpose of illustrating example embodiments.

According to example embodiments, profiles, ribbons, bands, and strands of polymer are placed in the skin, sub-skin, and core layers of the film web to modify the final properties and the appearance of the resultant film.

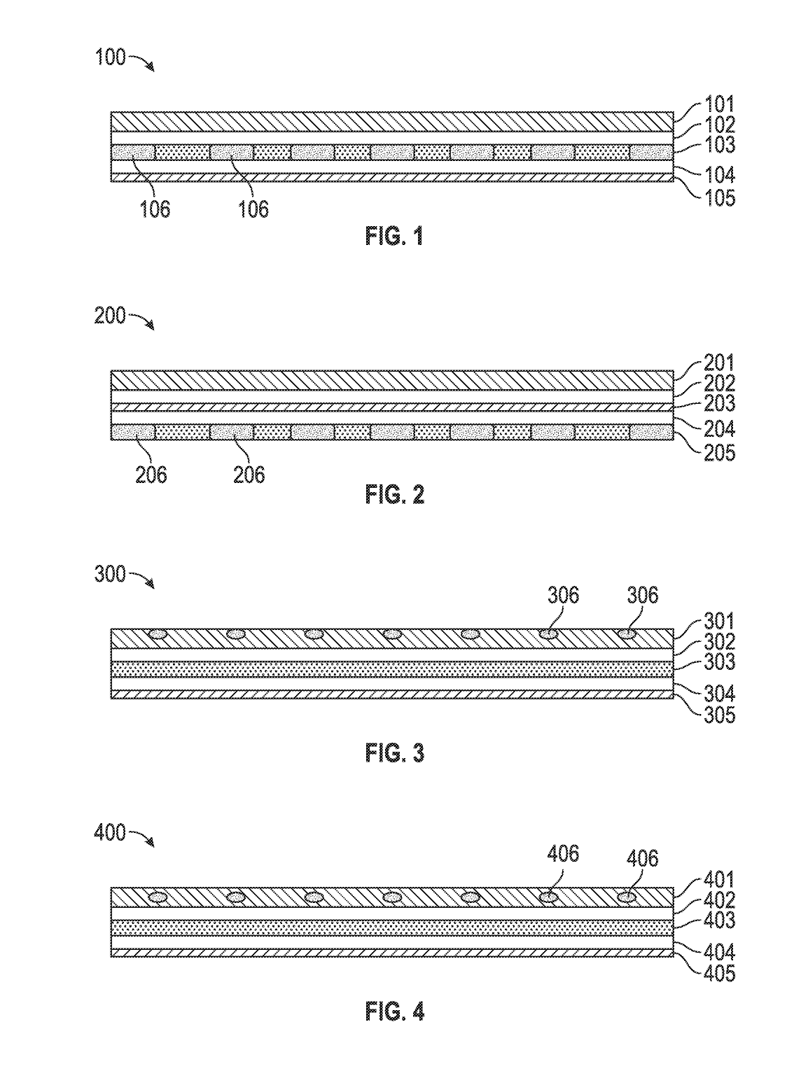

According to further example embodiments, utilizing a multi-manifold die, products and layer configurations, as shown in FIGS. 1-4 for example, are possible, along with multiple other configurations.

In further example embodiments, a feedblock, in conjunction with a multi-manifold die, allows separate polymer streams to be added to the film prior to the film exiting the die, resulting in a film web that has gauge variations similar to conventional multi-layer cast stretch films.

According to example embodiments, the feedblock (the device wherein the separate polymer streams from the extruders for each of the film's layers meet) has internal flow channels, created using flow distribution plates placed inside of the feedblock, for distributing the different polymer types for the film's layers to the combining adapter, wherein each of the polymer streams are joined together to form one layered stream of material with which in turn feeds the die.

According to example embodiments, this molten multi-layered stream next proceeds to the die, where it is reduced to the desired gauge as it passes through the die onto the casting unit.

In further embodiments, the die is a multi-manifold die. In certain embodiments, the multi-manifold die comprises at least one manifold for placing at least one profile, ribbon, band, or strand of material in one or more layers of the film, prior to the layered stream exiting the die.

In certain example embodiments, a “manifold” is a flow assembly that supplies at least one additional stream to the die. In other example embodiments, there are two or more “manifolds” supplying the die, resulting in the mating of several sub-structures that ultimately combine to create a stream exiting the die.

In further embodiments, the manifold comprises a channel from which one or more further channels lead into one or more layers of the layered stream, prior to the layered stream exiting the die.

According to example embodiments, a polymer stream is temperature sensitive and can only withstand an increase in temperature for a short period of time (about a couple of seconds) before it starts degrading. In certain embodiments, this polymer stream is processed and distributed within its own manifold. In further embodiments, the temperature sensitive polymer stream is processed and distributed with other low temperature polymers in the manifold, before it is joined with the layered stream from the feedblock within the multi-manifold die, just before the layered stream exits the die. In further embodiments, the layered stream is then passed from the die onto the casting unit, cooling the resulting film web.

In a further example embodiment, the contact time of materials that are reactive with each other is controlled or minimized using the multi-manifold die before the film web is quenched.

In still further embodiments, a desired profile or resin placement within a structure is combined at the desired location just prior to the stream exiting the die.

In certain embodiments, the manifold comprises a pipe from which other smaller pipes are directed into one or more layers of the resulting film before the film exits the die. In further embodiments, the pipes are cylindrical in shape, although other shapes of pipe are contemplated herein, depending on the desired shape and configuration of the profiles or bands in the film.

In certain embodiments, each of the film's layers are produced with varying thicknesses or profiles, and are continuous across the complete web. In some embodiments, the profiles are localized (i.e., near the edges or just the edges and several strands spaced across the channel) and result in a structure of multiple layers with varying geometries and configurations.

In still other embodiments, the variations in polymers within the structure, along with their differences in width, depth and placement within the structure and on the surface of the structure, provide the ability to provide integral strength bands, localized areas of coefficient of friction (COF), areas of significantly higher or lower modulus, areas of opaqueness or of color, and other properties.

In still further embodiments, the feedblock allows different layer configurations to be placed into varying geometries. In example embodiments, different layer configurations are possible by adjusting the feed distribution plates inside of the feedblock.

In still other embodiments, materials are introduced into any layer in any configuration or width desired, or into multiple layers using the multi-manifold die.

In an example embodiment, an encapsulated product is moved from the core to the skin by changing the flow diverters (also referred to herein as flow distribution plates) in a multi-channel feedblock. In certain embodiments, the multi-channel feedblock allows a polymer stream from a given extruder to be redirected within the feedblock to a different position within the structure.

In an example embodiment, Resin from Extruder A is on the outside of a three-layer structure such as ABC. In further embodiments, by changing the existing flow distribution plate (by rotating or sliding a valved assembly, or by manually replacing a flow plug), the structure is reconfigured to end up with the polymer from Extruder A in the core versus the skin, resulting in a BAC structure.

In further example embodiments, the multi-manifold die is designed to introduce materials of widely diverse rheologies into the film. In other embodiments, polymers that are not interdispersable, or polymers that require encapsulation, are added to the layered stream in the multi-manifold die, allowing for the placement of these materials into the polymer web as a profile, as opposed to an entire layer.

According to an example embodiment, more expensive, higher performance resins are placed into a film that utilizes conventional resins, providing for a higher performance product with only a minimal increase in cost.

In certain embodiments, higher performance, more expensive resins such as metallocene-catalyzed linear low density polyethylene (m-LLDPE), nylon, polyethylene terephthalate (PET), plastomers and elastomers, ionomers, low density polyethylene (LDPE), metallocene-catalyzed polypropylene (m-PP), and thermoplastic elastomers (TPE) are used.

In other embodiments, these higher performance resins are used with commodity resins, such as butene, hexane, or LLDPE, or with recycled or reprocessed resins, or combinations thereof, to yield products of significantly higher performance than the commodity resins.

According to still another embodiment, materials which have advantages as a string or a strand are selectively placed into the film web using the multi-manifold die. Such materials ordinarily negatively affect the performance of a film when they are introduced as a continuous layer, but have advantages as a string or strand.

As a continuous, discrete layer in a structure, according to example embodiments, resins such as low melt index m-LLDPEs, LDPE, PET, nylons and plastomers/elastomers negatively affect the overall performance of the film, but as controlled strands or strings, they are very beneficial in providing increased load containment and tear protection.

According to example embodiments, incorporating such materials results in significant performance modifications currently not possible with conventional cast stretch film technologies.

According to example embodiments, materials are incorporated into the film web to improve strength, tear propagation, load holding force, and extensibility.

In further embodiments, differentiated cling or release products are utilized on the external layer(s) of the film.

Turning now to FIG. 1, according to an example embodiment, the film 100 comprises five layers 101-105. According to example embodiments, the skin layers 101 and 105 have different thicknesses and compositions. However, in other embodiments, the skin layers 101 and 105 have identical thicknesses and/or compositions.

The sub-skin layers 102 and 104, in this example embodiment, have identical compositions, but different thicknesses. The core layer 103 is of a different composition than the skin layers 101 and 105 and the sub-skin layers 102 and 104, and comprises polymer bands 106, which are of a different composition than the core layer 103. In example embodiments, the film 100 comprises seven (7) laterally spaced longitudinally extending polymer bands 106 spaced from the opposite side edges of the film 100. According to example embodiments, the polymer bands 106 improve the strength, tear propagation, load holding force, and extensibility of the film 100.

According to example embodiments, the film 100 is produced in-process, and a separate operation for incorporating the polymer bands 106 is not required. In certain embodiments, the bands 106 are introduced into the film web using a multi-manifold die.

Turning now to FIG. 2, according to example embodiments, the film 200 comprises five layers 201-205. According to further embodiments, the skin layers 201 and 205 have different thicknesses and compositions. However, in other embodiments, the skin layers 201 and 205 have identical thicknesses and/or compositions.

The sub-skin layers 202 and 204, in this example embodiment, have identical compositions and thicknesses. The core layer 203 is of a different composition than the skin layers 201 and 205 and the sub-skin layers 202 and 204.

In example embodiments, the skin layer 205 further comprises polymer bands 206, which are a different composition than the skin layer 205. In example embodiments, the film 200 comprises seven (7) laterally spaced longitudinally extending polymer bands 206 spaced from the opposite side edges of the film 200. In further embodiments, the polymer bands 206 comprise differentiated cling or release products.

According to example embodiments, the film 200 is produced in-process, and a separate operation for incorporating the polymer bands 206 into the skin layer 205 is not required. In certain embodiments, the bands 206 are introduced into the film web using a multi-manifold die.

Turning next to FIG. 3, according to still further embodiments, the film 300 comprises five layers 301-305. According to example embodiments, the skin layers 301 and 305 have different thicknesses and compositions. However, in other embodiments, the skin layers 301 and 305 have identical thicknesses and/or compositions.

The sub-skin layers 302 and 304, in this example embodiment, have identical compositions, but different thicknesses. The core layer 303 is of a different composition than the skin layers 301 and 305 and the sub-skin layers 302 and 304.

In example embodiments, the skin layer 301 further comprises polymer strands 306, which are of a different composition than the skin layer 301. In example embodiments, the film 300 comprises seven (7) laterally spaced longitudinally extending polymer strands 306 spaced from the opposite side edges of the film 300. In further embodiments, the polymer strands 306 comprise differentiated cling or release products.

According to example embodiments, the film 300 is produced in-process, and a separate operation for incorporating the polymer strands 306 into the skin layer 301 is not required. In certain embodiments, the strands 306 are introduced into the film web using a multi-manifold die.

Turning now to FIG. 4, according to still further embodiments, the film 400 comprises five layers 401-405. According to example embodiments, the skin layers 401 and 405 have different thicknesses and compositions. However, in other embodiments, the skin layers 401 and 405 have identical thicknesses and/or compositions.

The sub-skin layers 402 and 404, in this example embodiment, have identical compositions, but different thicknesses. The core layer 403 is of a different composition than the skin layers 401 and 405 and the sub-skin layers 402 and 404.

According to example embodiments, the skin layer 401 comprises internal polymer strands 406, which are a different composition than the skin layer 401. In example embodiments, the skin layer 401 of the film 400 comprises seven (7) laterally spaced longitudinally extending polymer strands 406 spaced from the opposite side edges of the film 400. According to example embodiments, the polymer strands 406 improve the strength, tear propagation, load holding force, and extensibility of the film 400.

According to example embodiments, the film 400 is produced in-process, and a separate operation for incorporating the polymer strands 406 is not required. In certain embodiments, the bands 406 are introduced into the film web using a multi-manifold die.

In further example embodiments, resins used to produce the film layers include, but are not limited to, Ziegler Natta (ZN) catalyzed linear low density polyethylene (ZN-LLDPE), metallocene-catalyzed linear low density polyethylene (m-LLDPE), polyethylenes, polyethylene copolymers, polyethylene terpolymers, polyethylene blends, polypropylenes, polypropylene copolymers, metallocene catalyzed polypropylenes, metallocene catalyzed polypropylene copolymers, and blends thereof.

According to example embodiments, both migratory (i.e. polybutene polymers) and non-migratory polymers and/or additives such as waxes, rosins, ethylene vinyl acetates, ethylene methacrylates, ethylene methylmethacrylates, plastomers, elastomers, very low density copolymer polyethylenes, ultra-low density polyethylenes, copolymer polypropylenes, etc. and blends thereof are used as cling agents in the film. According to certain embodiments, a polybutene polymer with a Saybolt Universal Viscosity of 14,900 SUS at 99° C. with an average molecular weight of 2,060 is used as a cling agent. In further example embodiments, a polybutene polymer with a Saybolt Universal Viscosity of 3,000 SUS at 99° C. with an average molecular weight of 1,290 is used as the cling agent incorporated into the skin layers of the film.

According to other example embodiments, materials for color banding are incorporated into one or more of the external layers of the film. In certain embodiments, such materials are inserted to detect tamper resistance. In other embodiments, the materials are incorporated to be used as a product/lot identifier for shipment, or as a storage date identifier.

In still further example embodiments, resins with different refractive indexes are incorporated into the film for visual effects.

In other example embodiments, rubberized material is incorporated into the stretch film web for stretch recovery. Other example embodiments include: introduction of radio frequency (RF) active materials for melting/heat sealing and encapsulation of polymer strands for materials that require tie layers.

Benefits according to example embodiments include the ability to utilize novel or non-traditional resins with significantly different properties versus conventional cast stretch film resins.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions, and additions may also be made without departing from the spirit or scope thereof.

1. A die for forming a stretch film, said die comprising:
a primary passage for receiving a primary stream, said primary passage having a length extending from a die inlet opening to a die outlet opening; and
a flow assembly for supplying a secondary stream to said primary passage at a secondary passage opening located upstream of the die outlet opening.

2. The die of claim 1, wherein said flow assembly is a manifold, said manifold comprising a manifold inlet opening for receiving said secondary stream and a manifold outlet opening, said manifold outlet opening disposed in communication with said secondary passage opening.

3. The die of claim 2, wherein said manifold is approximately cylindrical in shape.

4. The die of claim 3, further wherein said manifold comprises a tubular.

5. The die of claim 1, wherein said primary passage further comprises a plurality of secondary passage openings positioned substantially equidistant from each other across a width of said primary passage.

6. The die of claim 5, said manifold further comprising a plurality of manifold outlet openings, further wherein said plurality of secondary passage openings are disposed in communication with said plurality of manifold outlet openings.

7. The die of claim 6, wherein at least one of said plurality of secondary passage openings is capable of being closed.

8. The die of claim 6, wherein at least one of said plurality of manifold outlet openings is capable of being closed.

9. A method for forming a stretch film, said method comprising:
introducing a primary stream to a primary passage of a die at a die inlet opening, said primary passage having a length extending from said die inlet opening to a die outlet opening;
supplying a secondary stream to said primary passage at a secondary passage opening located upstream of the die outlet opening using a flow assembly;
combining said primary stream and said secondary stream to create a combined stream;
passing said combined stream through said die outlet opening; and
passing the combined stream from the die outlet opening to a casting unit, thereby forming a film web.

10. The method of claim 9, further comprising supplying said secondary stream to said primary passage using a manifold, said manifold comprising a manifold inlet opening and a manifold outlet opening, said manifold outlet opening disposed in communication with said secondary passage opening.

11. The method of claim 10, further comprising disposing said manifold in communication with said primary passage, wherein said manifold is approximately cylindrical in shape.

12. The method of claim 11, further comprising disposing a tubular in communication with said primary passage.

13. The method of claim 9, further comprising disposing a plurality of secondary passage openings positioned substantially equidistant from each other across a width of said main passage.

14. The method of claim 10, further comprising disposing said manifold in communication with said primary passage, wherein said manifold comprises a plurality of manifold outlet openings.

15. The method of claim 14, further comprising disposing said plurality of manifold outlet openings in communication with said plurality of secondary passage openings.

16. The method of claim 15, further comprising closing at least one of the plurality of secondary passage openings.

17. The method of claim 15, further comprising closing at least one of the plurality of manifold outlet openings.
